(19) United States
(12) Patent Application Publication
(10) Pub. No.: US 2018/0254139 A1
(43) Pub. Date: Sep. 6, 2018

(54) COIL-INCORPORATED COMPONENT

(71) Applicant: Murata Manufacturing Co., Ltd., Nagaokakyo-shi (JP)

(72) Inventor: Hirokazu YAZAKI, Nagaokakyo-shi (JP)

(21) Appl. No.: 15/973,560

(22) Filed: May 8, 2018

Related U.S. Application Data
(63) Continuation of application No. PCT/JP2016/088254, filed on Dec. 21, 2016.

(30) Foreign Application Priority Data
Dec. 24, 2015 (JP) 2015-252656

(51) Int. Cl. H01F 27/28; H01F 27/32; H01F 27/24

(52) U.S. Cl. CPC H01F 27/2804; H01F 2027/2809; H01F 27/24; H01F 27/323

(57) ABSTRACT

A coil-incorporated component includes a first coil element including a first coil pattern and a second coil pattern, and a second coil element including a third coil pattern and a fourth coil pattern. The first coil pattern and the third coil pattern are provided in a first base material layer, the second coil pattern and the fourth coil pattern are provided in a second base material layer. When a coil-incorporated component is viewed from a lamination direction, the first coil pattern and the fourth coil pattern at least partially overlap with each other, the second coil pattern and the third coil pattern at least partially overlap with each other. An intermediate layer having a low magnetic permeability is provided between the first coil pattern and the fourth coil pattern and between the second coil pattern and the third coil pattern.

### CROSS REFERENCE TO RELATED APPLICATIONS

This application claims the benefit of priority to Japanese Patent Application No. 2015-252656 filed on Dec. 24, 2015 and is a Continuation Application of PCT Application No. PCT/JP2016/088254 filed on Dec. 21, 2016. The entire contents of each application are hereby incorporated herein by reference.

### BACKGROUND OF THE INVENTION

### 1. Field of the Invention

The present invention relates to a coil-incorporated component, and particularly, to a multilayer type coil-incorporated component in which two coil elements are incorporated.

### 2. Description of the Related Art

An existing coil-incorporated component with two coil elements formed in a multilayer substrate is known (for example, see Japanese Unexamined Patent Application Publication No. 2015-73052).

A coil-incorporated component disclosed in Japanese Unexamined Patent Application Publication No. 2015-73052 includes a multilayer element body formed by laminating a plurality of magnetic body layers and a first coil element and a second coil element provided in the multilayer element body. The first coil element and the second coil element are separately arranged upward and downward in a lamination direction, and configured so as to couple with each other through a magnetic field. A non-magnetic body portion is provided between a coil pattern of the first coil element and a coil pattern of the second coil element which are adjacent to each other in the lamination direction.

In general, in order to enhance an inductance value and magnetic field coupling of a coil-incorporated component in which two coil elements are incorporated, the number of laminated layers of the coil-incorporated component is increased and the number of turns of the coils is increased. However, in a case in which the number of laminated layers is simply increased, the inductance value can be increased, but the magnetic field coupling between the two coil elements cannot be improved. In other words, in a structure in which the first coil element and the second coil element are separately arranged upward and downward such as the coil-incorporated component disclosed in Japanese Unexamined Patent Application Publication No. 2015-73052, it is difficult to improve the magnetic field coupling between the two coil elements.

### SUMMARY OF THE INVENTION

Preferred embodiments of the present invention provide coil-incorporated components capable of improving magnetic field coupling between two coil elements.

A coil-incorporated component according to a preferred embodiment of the present invention includes a multilayer element body including a plurality of magnetic body layers that are laminated, and a first coil element and a second coil element provided in the multilayer element body, in which the multilayer element body includes a first base material layer including one or more of the magnetic body layers and a second base material layer including one or more of the magnetic body layers and provided in a lamination direction with respect to the first base material layer, the first coil element includes a first coil pattern and a second coil pattern connected to each other, the second coil element includes a third coil pattern and a fourth coil pattern connected to each other, the first coil pattern and the third coil pattern are provided in the first base material layer, the second coil pattern and the fourth coil pattern are provided in the second base material layer, when viewed from the lamination direction, the first coil pattern and the fourth coil pattern at least partially overlap with each other, the second coil pattern and the third coil pattern at least partially overlap with each other, an intermediate layer having a lower magnetic permeability than that of the magnetic body layer is provided between the first coil pattern and the fourth coil pattern and between the second coil pattern and the third coil pattern.

According to this configuration, the first coil pattern and the fourth coil pattern couple with each other through a magnetic field with the intermediate layer interposed therebetween, the second coil pattern and the third coil pattern couple with each other through the magnetic field with the intermediate layer interposed therebetween. Accordingly, the number of points at which the first coil element and the second coil element couple with each other through the magnetic field increases, and thus, the magnetic field coupling between the first coil element and the second coil element is able to be improved.

Additionally, when the coil-incorporated component is viewed from the lamination direction, the first coil pattern may be provided in an inner side portion of the third coil pattern, and the fourth coil pattern may be provided in an inner side portion of the second coil pattern.

According to this configuration, magnetic field coupling between the first coil pattern and the third coil pattern and magnetic field coupling between the second coil pattern and the fourth coil pattern is able to be obtained, such that magnetic field coupling between the first coil element and the second coil element is able to be improved.

Additionally, a coil axis of the first coil element and a coil axis of the second coil element may be same with each other.

According to this configuration, magnetic fields provided in the coil patterns are able to be coupled with each other with high efficiency, and thus, coupling between the magnetic field provided by the first coil element and the magnetic field provided by the second coil element is able to be further improved.

Additionally, the first coil pattern and the fourth coil pattern may have the same coil diameter, and the second coil pattern and the third coil pattern may have the same coil diameter.

According to this configuration, coupling between the magnetic field provided by the first coil pattern and the magnetic field provided by the fourth coil pattern are able to be further improved. Additionally, coupling between the magnetic field provided by the second coil pattern and the magnetic field provided by the third coil pattern are able to be further improved.

Additionally, the magnetic body layer in which the first coil pattern and the third coil pattern are provided may include the first coil pattern and the third coil pattern each including one turn or less by one layer thereof, the magnetic body layer in which the second coil pattern and the fourth coil pattern are provided may include the second coil pattern and the fourth coil pattern each including one turn or less by one layer thereof.

According to this configuration, in comparison to a case in which one layer of the magnetic body layer includes a coil pattern whose number of turns is more than one turn, capacitive coupling between the coil patterns opposing each other in the lamination direction is able to be reduced. As a result, it is possible to reduce or prevent an inductance value of the coil-incorporated component from reducing.

Additionally, the first base material layer may include a plurality of the first coil patterns that are mutually adjacent in the lamination direction and a plurality of the third coil patterns that are mutually adjacent in the lamination direction, and the second base material layer may include a plurality of the second coil patterns that are mutually adjacent in the lamination direction and a plurality of the fourth coil patterns that are mutually adjacent in the lamination direction.

According to this configuration, the inductance value of each of the first coil element and the second coil element is able to be increased, and the magnetic field coupling between the first coil element and the second coil element is able to be improved.

Additionally, the intermediate layer may be provided in an entire or substantially an entire region perpendicular or substantially perpendicular to the lamination direction of the multilayer element body between the first coil pattern and the fourth coil pattern adjacent to each other in the lamination direction and between the second coil pattern and the third coil pattern adjacent to each other in the lamination direction.

According to this configuration, the intermediate layer having a low magnetic permeability in the multilayer element body is able to be easily provided.

Additionally, the intermediate layer may not be provided between the magnetic body layer in an inner side portion of the first coil pattern and the magnetic body layer in an inner side portion of the fourth coil pattern, and may be provided between the first coil pattern and the fourth coil pattern adjacent to each other in the lamination direction, between the second coil pattern and the third coil pattern adjacent to each other in the lamination direction, and between the magnetic body layer between the first coil pattern and the third coil pattern and the magnetic body layer between the second coil pattern and the fourth coil pattern.

According to this configuration, in the inner side portion of the first coil pattern and in the inner side portion of the fourth coil pattern, a magnetic flux along the coil axis is not interfered with by the intermediate layer, and thus, the magnetic field coupling between the first coil element and the second coil element is able to be further improved.

According to preferred embodiments of the present invention, magnetic field coupling between two coil elements incorporated in coil-incorporated components are able to be improved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a coil-incorporated component according to a first preferred embodiment of the present invention.

FIG. 2A is a schematic diagram illustrating a cross-section of the coil-incorporated component according to the first preferred embodiment of the present invention.

FIG. 2B is a diagram of the coil-incorporated component according to the first preferred embodiment of the present invention when viewed from a lamination direction.

FIG. 3 illustrates an equivalent circuit of the coil-incorporated component according to the first preferred embodiment of the present invention.

FIG. 4 is a schematic diagram illustrating a cross-section of a coil-incorporated component of a first variation of the first preferred embodiment of the present invention.

FIG. 5 is a schematic diagram illustrating a cross-section of a coil-incorporated component of a second variation of the first preferred embodiment of the present invention.

FIG. 6 is a schematic diagram illustrating a cross-section of a coil-incorporated component according to a second preferred embodiment of the present invention.

FIG. 7 is a diagram illustrating constituent elements of the coil-incorporated component illustrated in FIG. 6 (i.e., magnetic body layer, intermediate layer, coil pattern, routing conductor pattern, and external terminal), (a) to (o) are diagrams when each of the layers is viewed from a lower surface side.

FIG. 8 is a schematic diagram illustrating a cross-section of a coil-incorporated component according to a third preferred embodiment of the present invention.

FIG. 9 illustrates an equivalent circuit of the coil-incorporated component according to the third preferred embodiment of the present invention.

FIG. 10 is a cross-sectional view of a resin multilayer substrate including the coil-incorporated component according to the third preferred embodiment of the present invention in the inside thereof.

### DETAILED DESCRIPTION OF THE PREFERRED EMBODIMENTS

Preferred embodiments of the present invention will be described in detail with reference to the drawings. Note that, all preferred embodiments described below are comprehensive or specific examples. Numerical values, shapes, materials, constituent elements, arrangement and connection configurations of the constituent elements, manufacturing steps, orders of the manufacturing steps, and the like, which will be described in the following preferred embodiments, are examples and are not intended to limit the present invention. Constituent elements which are not described in independent claims among the constituent elements in the following preferred embodiments are described as arbitrary constituent elements.

Note that, the drawings are schematically illustrated, and are not necessarily strictly illustrated. Additionally, in the drawings, configurations that are substantially identical are given identical reference numerals, redundant descriptions thereof will be omitted or simplified.

### First Preferred Embodiment

A coil-incorporated component according to a first preferred embodiment of the present invention includes two coil elements that are incorporated. This coil-incorporated component is not limited to a configuration to be incorporated in a dual inductor, such as a common mode choke coil, a transformer, a coupler, a balun, or other dual inductor, may have a configuration to be incorporated in a multilayer circuit component, such as a choke coil or other suitable coil of a multiphase DC-DC converter. The present preferred embodiment will be described using a dual inductor as an example of the coil-incorporated component.

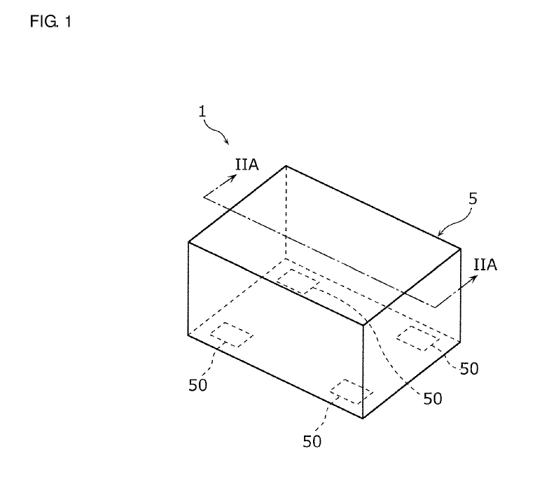

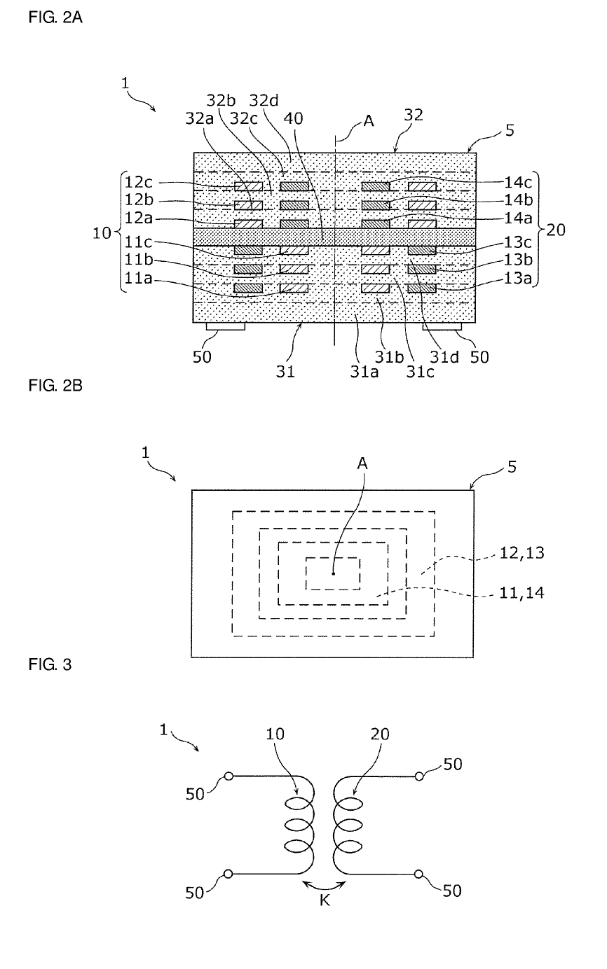

FIG. 1 is a perspective view of a coil-incorporated component 1 according to the present preferred embodiment. FIG. 2A is a cross sectional view of the coil-incorporated component 1 taken along a line IIA-IIA in FIG. 1, FIG. 2B is a diagram of the multilayer type coil-incorporated component 1 when viewed from a lamination direction. FIG. 3 illustrates an equivalent circuit of the coil-incorporated component 1.

The coil-incorporated component 1 includes, as illustrated in FIG. 1, a multilayer element body 5 and a plurality of external terminals 50 provided on a bottom surface of the multilayer element body 5.

In the inside of the multilayer element body 5, as illustrated in FIG. 2A, a first coil element 10 and a second coil element 20 are provided. The first coil element 10 includes a first coil pattern 11 (11a, 11b, and 11c) and a second coil pattern 12 (12a, 12b, and 12c) which are connected to each other in series. The second coil element 20 includes a third coil pattern 13 (13a, 13b, and 13c) and a fourth coil pattern 14 (14a, 14b, and 14c) which are connected to each other in series. The first coil pattern 11, the second coil pattern 12, the third coil pattern 13, and the fourth coil pattern 14 are each preferably wound in a rectangular or substantially rectangular shape with a coil axis A as the center or approximate center, as illustrated in FIG. 2B. In other words, the first coil element 10 and the second coil element 20 preferably have an identical or substantially identical coil axis A, and are coupled with each other through a magnetic field (see FIG. 3).

Note that, although the coil-incorporated component 1 includes an interlayer conductor (via conductor) connecting each of the coil patterns and a routing conductor pattern, FIGS. 2A and 2B do not illustrate this.

The multilayer element body 5 includes a first base material layer 31 and a second base material layer 32, and an intermediate layer 40 provided between the first base material layer 31 and the second base material layer 32.

The first base material layer 31 includes a plurality of magnetic body layers 31a, 31b, 31c, and 31d that are laminated. The second base material layer 32 includes a plurality of magnetic body layers 32a, 32b, 32c, and 32d that are laminated. The second base material layer 32 is provided on one side (upper portion in the present preferred embodiment) in the lamination direction with respect to the first base material layer 31 with the intermediate layer 40 interposed therebetween.

As a material of the magnetic body layers 31a to 31d and 32a to 32d, for example, a magnetic ferrite ceramic material is preferably used. Specifically, for example, ferrite including iron oxide as a primary component and including at least one or more of zinc, nickel, and copper is preferably used.

The intermediate layer 40 is provided in the entire or substantially the entire region perpendicular or substantially perpendicular to the lamination direction of the multilayer element body 5 between the first coil pattern 11c and the fourth coil pattern 14a and between the second coil pattern 12a and the third coil pattern 13c which are adjacent to each other in the lamination direction. Additionally, the intermediate layer 40 is in contact with each of the first coil pattern 11c and the third coil pattern 13c on a lower surface side thereof, and is in contact with each of the second coil pattern 12a and the fourth coil pattern 14a on an upper surface side thereof.

The intermediate layer 40 has a lower magnetic permeability than those of the magnetic body layers 31a to 31d and 32a to 32d. As a material of the intermediate layer 40, a material having a lower relative magnetic permeability than those of materials of the magnetic body layers 31a to 31d and 32a to 32d, for example, non-magnetic ferrite ceramic material, and an insulative glass ceramic material including glass and alumina as primary components are preferably used. Note that, this intermediate layer 40 is referred to as a non-magnetic body layer in some cases.

The first coil patterns 11a, 11b, and 11c which are portions of the first coil element 10 are provided in the first base material layer 31 while being mutually adjacent in the lamination direction. The second coil patterns 12a, 12b, and 12c which are portions of the first coil element 10 are provided in the second base material layer 32 while being mutually adjacent in the lamination direction. The third coil patterns 13a, 13b, and 13c which are portions of the second coil element 20 are provided in the first base material layer 31 while being mutually adjacent in the lamination direction. The fourth coil patterns 14a, 14b, and 14c which are portions of the second coil element 20 are provided in the second base material layer 32 while being mutually adjacent in the lamination direction.

Additionally, the first coil pattern 11 is provided in an inner side portion of the third coil pattern 13. The first coil patterns 11a, 11b, and 11c and the third coil patterns 13a, 13b, and 13c are respectively adjacent to each other in a direction perpendicular or substantially perpendicular to the lamination direction. The fourth coil pattern 14 is provided in an inner side portion of the second coil pattern 12. The second coil patterns 12a, 12b, and 12c and the fourth coil patterns 14a, 14b, and 14c are respectively adjacent to each other in a direction perpendicular or substantially perpendicular to the lamination direction. With this, the first coil element 10 and the second coil element 20 are arranged in opposite directions from each other in the lamination direction, and have a structure in which both of the elements enter each other.

Additionally, the first coil pattern 11 and the fourth coil pattern 14 preferably have the same or substantially the same coil diameter. The second coil pattern 12 and the third coil pattern 13 have the same coil diameter. The same coil diameter refers to, in a case in which two coil patterns to be compared have rectangular or substantially rectangular shapes, the two coil patterns having the same or substantially the same long side length and the same or substantially the same short side length. Note that, the first coil pattern 11, the second coil pattern 12, the third coil pattern 13, and the fourth coil pattern 14 have the same or substantially the same width dimension, and also have the same or substantially the same thickness dimension.

As a material of the first coil pattern 11, the second coil pattern 12, the third coil pattern 13, and the fourth coil pattern 14, for example, a metal or an alloy including silver as a primary component is preferably used. Each of these coil patterns may be plated with nickel, palladium, or gold, for example.

In the present preferred embodiment, as illustrated in FIG. 2B, when the coil-incorporated component 1 is viewed from the lamination direction, the first coil pattern 11 and the fourth coil pattern 14 overlap with each other, and the second coil pattern 12 and the third coil pattern 13 overlap with each other. Additionally, both of a winding axis of the first coil pattern 11 and the fourth coil pattern 14 and a winding axis of the second coil pattern 12 and the third coil pattern 13 are on the same or substantially the same straight line (on the coil axis A). With this structure, in a case in which a voltage is applied to each of the first coil element 10 and the second coil element 20, a magnetic flux interlinking across both the first coil pattern 11 and the fourth coil pattern 14 and a magnetic flux interlinking across both the second coil pattern 12 and the third coil pattern 13, which are magnetic fluxes along the coil axis A, are provided. In other words, the coil-incorporated component 1 is configured such that the first coil pattern 11 and the fourth coil pattern 14 which sandwich the intermediate layer 40 couple with each other through the magnetic field, and the second coil pattern 12 and the third coil pattern 13 which sandwich the intermediate layer 40 couple with each other through the magnetic field.

Next, non-limiting examples of manufacturing steps of the coil-incorporated component 1 will be described.

First, a ceramic green sheet for each layer is prepared. Specifically, the ceramic green sheet for the magnetic body layer is prepared by sheet-molding of slurry including magnetic body ceramic powder, the ceramic green sheet for the intermediate layer is prepared by sheet-molding of slurry including non-magnetic body ceramic powder.

Next, in a predetermined ceramic green sheet, a plurality of through-holes are formed and the through-holes are filled with a conductor paste to form a plurality of via conductors, and the first coil pattern 11 and the third coil pattern 13 or the second coil pattern 12 and the fourth coil pattern 14 are formed by printing with a conductor paste on a main surface. The through-holes are, for example, formed through a laser process. The first coil pattern 11, the second coil pattern 12, third coil pattern 13, and the fourth coil pattern 14 are, for example, patterned by screen printing using a conductor paste including Ag powder.

Next, a plurality of ceramic green sheets on which the conductor paste is arranged are stacked and pressure-bonded, cut to be singulated, and then collectively subjected to firing. By this firing, the magnetic body ceramic powder and non-magnetic body ceramic powder in each of the green sheets are sintered, and the Ag powder in the conductor paste is sintered.

The magnetic body ceramics and the non-magnetic body ceramics are preferably LTCC ceramics (Low Temperature Co-fired Ceramics), the firing temperature thereof is a melting point of silver or lower, and thus, silver may preferably be used as a material of each of the coil patterns and the via conductors. By configuring the first coil element 10 and the second coil element using silver having low resistivity, the coil-incorporated component 1 with low loss is manufactured.

Additionally, by using a sheet lamination method in which the ceramic green sheets are laminated to manufacture the multilayer element body 5 as described above, the intermediate layer 40 may be formed in the entire or substantially the entire region perpendicular or substantially perpendicular to the lamination direction of the multilayer element body 5 with ease.

As described above, in the coil-incorporated component 1 according to the present preferred embodiment, when viewed from the lamination direction, the first coil pattern 11 of the first coil element 10 and the fourth coil pattern 14 of the second coil element 20 overlap with each other, and the second coil pattern 12 of the first coil element 10 and the third coil pattern 13 of the second coil element 20 overlap with each other. According to this structure, the first coil pattern 11 and the fourth coil pattern couple with each other through the magnetic field with the intermediate layer 40 interposed therebetween, the second coil pattern 12 and the third coil pattern 13 couple with each other through the magnetic field with the intermediate layer 40 interposed therebetween. As a result, the number of points at which the first coil element 10 and the second coil element 20 couple with each other through the magnetic field is increased.

For example, in the known coil-incorporated component described above, a pair of coil elements which oppose each other couple with each other through the magnetic field, the magnetic field coupling occurs at one point. In contrast, in the coil-incorporated component 1 according to the present preferred embodiment, the magnetic field coupling occurs at two points of the first coil pattern 11 and the fourth coil pattern 14 and the second coil pattern 12 and the third coil pattern 13. With this configuration, the number of the points of the magnetic field coupling increases, and magnetic field coupling between the first coil element 10 and the second coil element 20 is improved.

Note that, when the coil-incorporated component 1 is viewed from the lamination direction, the first coil pattern 11 and the fourth coil pattern 14 need not completely overlap with each other, it is sufficient to at least partially overlap with each other. Additionally, the second coil pattern 12 and the third coil pattern 13 need not completely overlap with each other, it is sufficient to at least partially overlap with each other.

Additionally, in the coil-incorporated component 1, the first coil pattern 11 is provided in the inner side portion of the third coil pattern 13, and the fourth coil pattern 14 is provided in the inner side portion of the second coil pattern 12. With this structure, the coil patterns adjacent in the direction perpendicular or substantially perpendicular to the lamination direction also couple with each other, and thus, the number of the points of the magnetic field coupling increases. Specifically, in the coil-incorporated component 1, the first coil patterns 11a and 11b and the third coil patterns 13a and 13b couple with each other, respectively, through the magnetic field, and the second coil patterns 12b and 12c and the fourth coil patterns 14b and 14c couple with each other, respectively, through the magnetic field. With this, the magnetic field coupling between the first coil element 10 and the second coil element 20 is further improved.

Additionally, in the coil-incorporated component 1, the first coil element 10 and the second coil element 20 are arranged in opposite directions from each other in the lamination direction, and have a structure in which both of the elements enter each other. With this, in comparison to a structure in which a plurality of coil patterns are simply stacked to the intermediate layer, a distance between the intermediate layer 40 and the first coil pattern 11a located on the outermost layer side is reduced. In the same manner, a distance between the intermediate layer 40 and each of the second coil pattern 12c, the third coil pattern 13a, and the fourth coil pattern 14c located on the outermost layer side is reduced. As a result, the magnetic field coupling between the first coil element 10 and the second coil element 20 is improved.

For example, in the coil-incorporated component in which the first coil element and the second coil element are separately arranged upward and downward as in the known component described above, a distance between the coil pattern located on the outermost layer side and the intermediate layer increases. Accordingly, a magnetic flux (minor loop) circulating around the periphery of a line of the coil pattern on the outermost layer side occurs, the improvement of the magnetic field coupling is limited. However, the coil-incorporated component 1 according to the present preferred embodiment has a structure in which the first coil element 10 and the second coil element 20 enter with each other, in a case in which the number of turns of the coil is the same or substantially the same as that of the known component, the distance between the intermediate layer 40 and the first coil pattern 11a located on the outermost layer side is therefore reduced. Accordingly, it is possible to reduce or prevent the magnetic flux circulating around the periphery of the line of the first coil pattern 11a from occurring. In the same manner, the distance between the intermediate layer 40 and each of the second coil pattern 12c, the third coil pattern 13a, and the fourth coil pattern 14c located on the outermost layer side is reduced. Accordingly, it is possible to reduce or prevent a magnetic flux circulating around the periphery of a line of each of the second coil pattern 12c, the third coil pattern 13a, and the fourth coil pattern 14c from occurring. As a result, the magnetic field coupling between the first coil element 10 and the second coil element 20 is able to be improved. Additionally, a thickness of the coil-incorporated component 1 is able to be reduced.

Next, coil-incorporated components according to variations of the first preferred embodiment will be described.

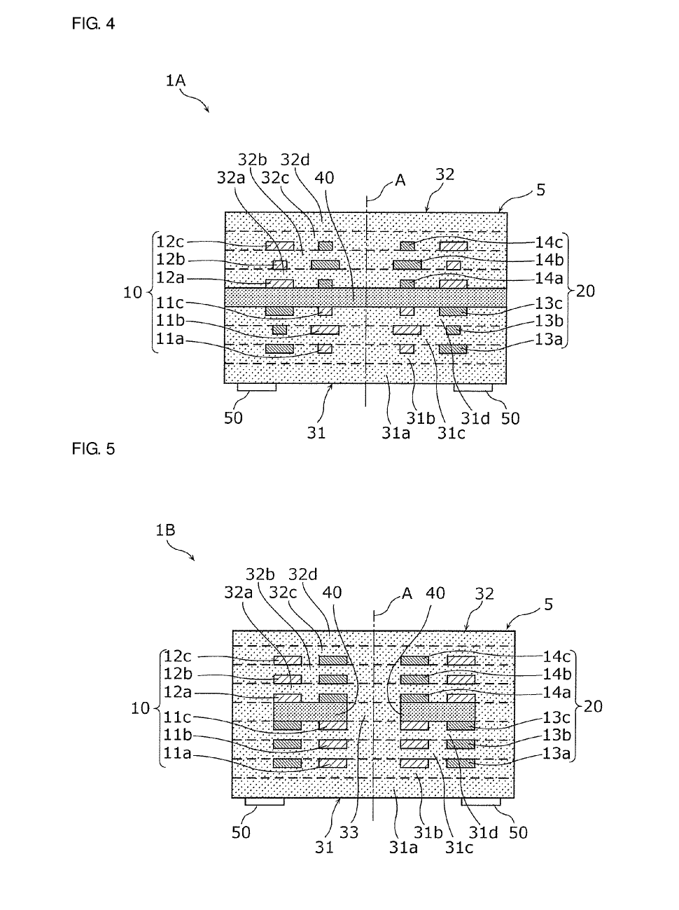

FIG. 4 is a schematic diagram illustrating a cross-section of a coil-incorporated component 1A of a first variation of the first preferred embodiment. In the coil-incorporated component 1A of the first variation, widths of the coil patterns adjacent in the lamination direction are preferably different.

Specifically, widths of the first coil patterns 11a and 11c are smaller than a width of the first coil pattern 11b, widths of the second coil patterns 12a and 12c are larger than a width of the second coil pattern 12b. Additionally, widths of the third coil patterns 13a and 13c are larger than a width of the third coil pattern 13b, widths of the fourth coil patterns 14a and 14c are smaller than a width of the fourth coil pattern 14b.

In the coil-incorporated component 1A of the first variation, when viewed from the lamination direction, the first coil pattern 11 and the fourth coil pattern 14 partially overlap with each other, the second coil pattern 12 and the third coil pattern 13 partially overlap with each other. According to this structure, in the coil-incorporated component 1A, the number of the points at which the first coil element 10 and the second coil element 20 couple with each other through the magnetic field is increased, and thus, the magnetic field coupling is improved.

Additionally, in the coil-incorporated component 1A, widths of the coil patterns which are adjacent to each other in the lamination direction are changed, and thus, even in a case in which positional deviations occur in the direction perpendicular or substantially perpendicular to the lamination direction when producing the coil patterns, an overlap area of the coil patterns when viewed from the lamination direction is substantially the same. With this configuration, variations in capacitive coupling generated by the opposing two coil patterns are reduced or prevented, and manufacturing variations in the inductance value and the degree of magnetic field coupling of the coil-incorporated component 1A are reduced or prevented.

FIG. 5 is a schematic diagram illustrating a cross-section of a coil-incorporated component 1B according to a second variation of the first preferred embodiment of the present invention.

In the coil-incorporated component 1B of the second variation, the intermediate layer 40 is not provided in the entire region perpendicular or substantially perpendicular to the lamination direction of the multilayer element body 5, but is provided in a partial region.

Specifically, the intermediate layer 40 is preferably provided only between the first coil pattern 11c and the fourth coil pattern 14a adjacent to each other in the lamination direction, between the second coil pattern 12a and the third coil pattern 13c adjacent to each other in the lamination direction, and between the magnetic body layer between the first coil pattern 11 and the third coil pattern 13 and the magnetic body layer between the second coil pattern 12 and the fourth coil pattern 14. In other words, when viewed from the lamination direction, between the magnetic body layer 31d in the inner side portion of the first coil pattern 11c and the magnetic body layer 32a in the inner side portion of the fourth coil pattern 14a, the intermediate layer 40 is not provided, a third base material layer 33 made of the same material as those of the magnetic body layers 31a to 31d and 32a to 32d is preferably provided. Additionally, when viewed from the lamination direction, in an outer side portion of the third coil pattern 13 and an outer side portion of the second coil pattern 12, the intermediate layer 40 is not provided, and the third base material layer 33 is provided.

In the coil-incorporated component 1B of the second variation, when viewed from the lamination direction, the first coil pattern 11 and the fourth coil pattern 14 partially overlap with each other, the second coil pattern 12 and the third coil pattern 13 partially overlap with each other. According to this structure, in the coil-incorporated component 1B, the number of the points at which the first coil element 10 and the second coil element 20 couple with each other through the magnetic field is increased, and thus, the magnetic field coupling is improved.

Additionally, in the coil-incorporated component 1B, a magnetic flux (major loop) interlinking across the first coil element 10 and the second coil element 20, which is a magnetic flux provided along the coil axis A in the inner side portion of the first coil pattern 11 and the inner side portion of the fourth coil pattern 14, is not interfered with by the intermediate layer 40. With this, the magnetic field coupling between the first coil element 10 and the second coil element 20 is able to be further improved.

### Second Preferred Embodiment

Next, a coil-incorporated component according to a second preferred embodiment of the present invention will be described.

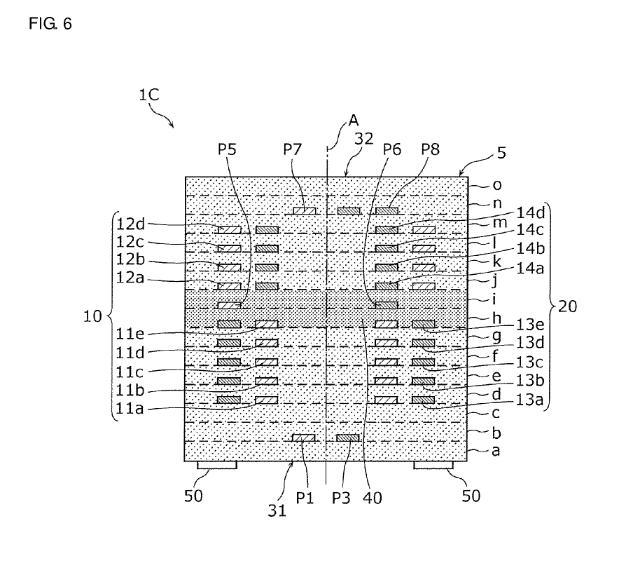

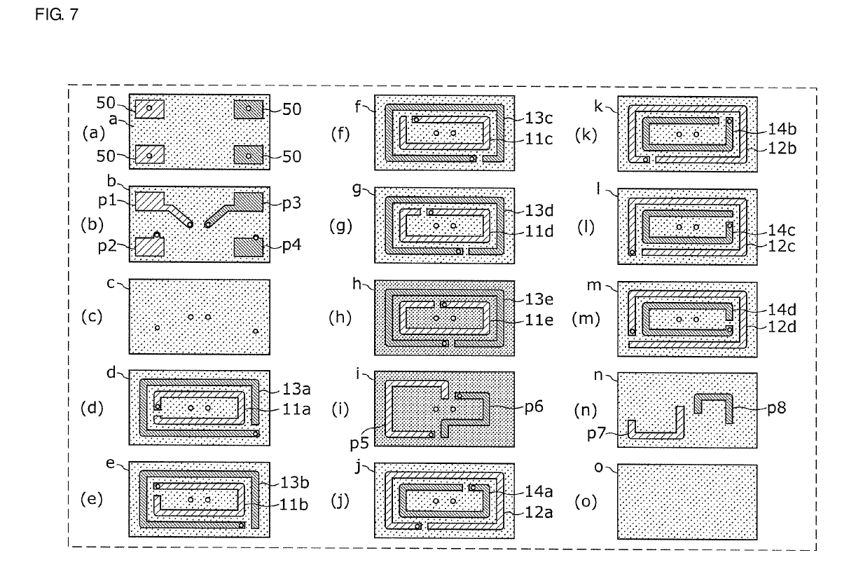

FIG. 6 is a schematic diagram illustrating a cross-section of a coil-incorporated component 1C according to the second preferred embodiment. FIG. 7 is a diagram illustrating magnetic body layers a to g and j to o, intermediate layers h and i, the first coil pattern 11, the second coil pattern 12, the third coil pattern 13, the fourth coil pattern 14, and routing conductor patterns p1 to p8 forming the coil-incorporated component 1C.

The coil-incorporated component 1C includes, as illustrated in FIG. 6, the multilayer element body 5 and a plurality of the external terminals 50 provided on the bottom surface of the multilayer element body 5.

In the inside of the multilayer element body 5, the first coil element 10 and the second coil element 20 are provided. The first coil element 10 includes the first coil pattern 11 (11a, 11b, 11c, 11d, and 11e) and the second coil pattern 12 (12a, 12b, 12c, and 12d) which are connected to each other in series. The second coil element 20 includes the third coil pattern 13 (13a, 13b, 13c, 13d, and 13e) and the fourth coil pattern 14 (14a, 14b, 14c, and 14d) which are connected to each other in series. The first coil pattern 11, the second coil pattern 12, the third coil pattern 13, and the fourth coil pattern 14 are each wound in a rectangular or substantially rectangular shape with the coil axis A as the center. In other words, the first coil element 10 and the second coil element 20 have the identical coil axis A, and are configured so as to couple with each other through the magnetic field.

The multilayer element body 5 includes the first base material layer 31 and the second base material layer 32, and the intermediate layers h and i provided between the first base material layer 31 and the second base material layer 32.

The first base material layer 31 is formed by laminating a plurality of the magnetic body layers a, b, c, d, e, f, and g. The second base material layer 32 is formed by laminating a plurality of the magnetic body layers j, k, l, m, n, and o. The second base material layer 32 is provided on one side (upper portion in the present preferred embodiment) in the lamination direction with respect to the first base material layer 31 with the intermediate layers h and i interposed therebetween.

The intermediate layers h and i are preferably provided in the entire or substantially the entire region perpendicular or substantially perpendicular to the lamination direction of the multilayer element body 5 between the first coil pattern 11e and the fourth coil pattern 14a and between the second coil pattern 12a and the third coil pattern 13e which are adjacent in the lamination direction. Additionally, the intermediate layers h and i are in contact with the first coil pattern 11e and the third coil pattern 13e on a lower surface side thereof, and in contact with the second coil pattern 12a and the fourth coil pattern 14a on the upper surface side thereof, respectively.

The first coil patterns 11a to 11e which are portions of the first coil element 10 are provided in the first base material layer 31 while being mutually adjacent in the lamination direction. The second coil patterns 12a to 12d which are portions of the first coil element 10 are provided in the second base material layer 32 while being mutually adjacent in the lamination direction. The third coil patterns 13a to 13e which are portions of the second coil element 20 are provided in the first base material layer 31 while being mutually adjacent in the lamination direction. The fourth coil patterns 14a to 14d which are portions of the second coil element 20 are provided in the second base material layer 32 while being mutually adjacent in the lamination direction.

Additionally, the first coil pattern 11 is provided in the inner side portion of the third coil pattern 13. The first coil patterns 11a to 11e and the third coil patterns 13a to 13e are respectively adjacent to each other in a direction perpendicular or substantially perpendicular to the lamination direction. The fourth coil pattern 14 is provided in the inner side portion of the second coil pattern 12. The second coil patterns 12a to 12d and the fourth coil patterns 14a to 14d are respectively adjacent to each other in a direction perpendicular or substantially perpendicular to the lamination direction. With this structure, the first coil element 10 and the second coil element 20 are arranged in opposite directions from each other in the lamination direction, and have a structure in which both the elements enter each other.

Additionally, the first coil pattern 11 and the fourth coil pattern 14 preferably have the same or substantially the same coil diameter. The second coil pattern 12 and the third coil pattern 13 preferably have the same or substantially the same coil diameter. Note that, preferably, the first coil pattern 11, the second coil pattern 12, the third coil pattern 13, and the fourth coil pattern 14 have the same or substantially the same width dimension, and have also the same or substantially the same thickness dimension.

In the present preferred embodiment, when the coil-incorporated component 1C is viewed from the lamination direction, the first coil pattern 11 and the fourth coil pattern 14 overlap with each other, and the second coil pattern 12 and the third coil pattern 13 overlap with each other. Additionally, both of a winding axis of the first coil pattern 11 and the fourth coil pattern 14 and a winding axis of the second coil pattern 12 and the third coil pattern 13 are on the same or substantially the same straight line (on the coil axis A). With this structure, in a case in which a voltage is applied to each of the first coil element 10 and the second coil element 20, a magnetic flux interlinking across both of the first coil pattern 11 and the fourth coil pattern 14 and a magnetic flux interlinking across both of the second coil pattern 12 and the third coil pattern 13, which are magnetic fluxes along the coil axis A, are provided. In other words, the coil-incorporated component 1C is configured such that the first coil pattern 11 and the fourth coil pattern 14 which sandwich the intermediate layers h and i couple with each other through the magnetic field, and the second coil pattern 12 and the third coil pattern 13 which sandwich the intermediate layers h and i couple with each other through the magnetic field.

Next, with reference to FIG. 7, elements of the coil-incorporated component 1C (magnetic body layer, intermediate layer, coil pattern, routing conductor pattern, and external terminal) will be described. In FIG. 7, (a) to (o) are diagrams of the magnetic body layers a to g and j to o, the intermediate layers h and i, the first coil pattern 11, the second coil pattern 12, the third coil pattern 13, the fourth coil pattern 14, and the routing conductor patterns p1 to p8 when viewed from a lower surface side. When stacking each of the layers a to o, (a) to (o) are stacked in this order in a state in which the lower surface of each of the layers a to o faces downward.

Note that, via conductors having round shapes are illustrated in (a) to (m) of FIG. 7. The via conductors connect the external terminals, the routing conductor patterns, and each of the coil patterns as illustrated in FIG. 7.

The magnetic body layer a illustrated in (a) of FIG. 7 is the outermost layer of the multilayer element body 5 on the lower side. The magnetic body layer a includes four external terminals 50 preferably having rectangular or substantially rectangular shapes being provided on the bottom surface side thereof.

In the magnetic body layer b illustrated in (b) of FIG. 7, the routing conductor patterns p1, p2, p3, and p4 are provided.

In the magnetic body layer c illustrated in (c) of FIG. 7, four via conductors are provided.

In the magnetic body layer d illustrated in (d) of FIG. 7, the first coil pattern 11a and the third coil pattern 13a are provided.

In the same or similar manner, in the magnetic body layer e, the first coil pattern lib and the third coil pattern 13b are provided. In the magnetic body layer f, the first coil pattern 11c and the third coil pattern 13c are provided. In the magnetic body layer g, the first coil pattern 11d and the third coil pattern 13d are provided.

In the intermediate layer h illustrated in (h) of FIG. 7, the first coil pattern 11e and the third coil pattern 13e are provided.

The number of turns of each of the first coil pattern 11 and the third coil pattern 13 which is provided in each of the magnetic body layers d to g and the intermediate layer h is preferably one turn or less, for example. Note that, the number of turns of each of the first coil pattern 11 and the third coil pattern 13 may be ½ turns or more and less than one turn, may be ¾ turns or more and less than one turn, may be ⅞ turns or more and less than one turn, or may be 15/16 turns or more and less than one turn, for example.

In the intermediate layer i illustrated in (i) of FIG. 7, the routing conductor patterns p5 and p6 are provided.

In the magnetic body layer j illustrated in (j) of FIG. 7, the second coil pattern 12a and the fourth coil pattern 14a are provided.

In the same or similar manner, in the magnetic body layer k, the second coil pattern 12b and the fourth coil pattern 14b are provided. In the magnetic body layer l, the second coil pattern 12c and the fourth coil pattern 14c are provided. In the magnetic body layer m, the second coil pattern 12d and the fourth coil pattern 14d are provided.

The number of turns of each of the second coil pattern 12 and the fourth coil pattern 14 which is provided in each of the magnetic body layers j to m is preferably one turn or less, for example. Note that, the number of turns of each of the second coil pattern 12 and the fourth coil pattern 14 may be ½ turns or more and less than one turn, may be ¾ turns or more and less than one turn, may be ⅞ turns or more and less than one turn, or may be 15/16 turns or more and less than one turn, for example.

In the magnetic body layer n illustrated in (n) of FIG. 7, the routing conductor patterns p7 and p8 are provided.

The magnetic body layer o illustrated in (o) of FIG. 7 is the outermost layer of the multilayer element body 5 on the upper side.

The magnetic body layers a to g, the intermediate layers h and i, and the magnetic body layers j to o are stacked in this order and pressed, and then are subjected to degreasing and firing to manufacture the coil-incorporated component 1C.

In the coil-incorporated component 1C described in the second preferred embodiment, the same or similar effects as in the coil-incorporated component 1 described in the first preferred embodiment are obtained. In other words, the degree of coupling between the first coil element 10 and the second coil element 20 is improved. For example, although a coupling coefficient K of both the coil elements is approximately 0.7 in the known coil-incorporated component, in the coil-incorporated component of the present preferred embodiment, a coupling coefficient K of both the coil elements is about 0.8 or more, for example.

### Third Preferred Embodiment

Next, a coil-incorporated component 1D according to a third preferred embodiment of the present invention will be described.

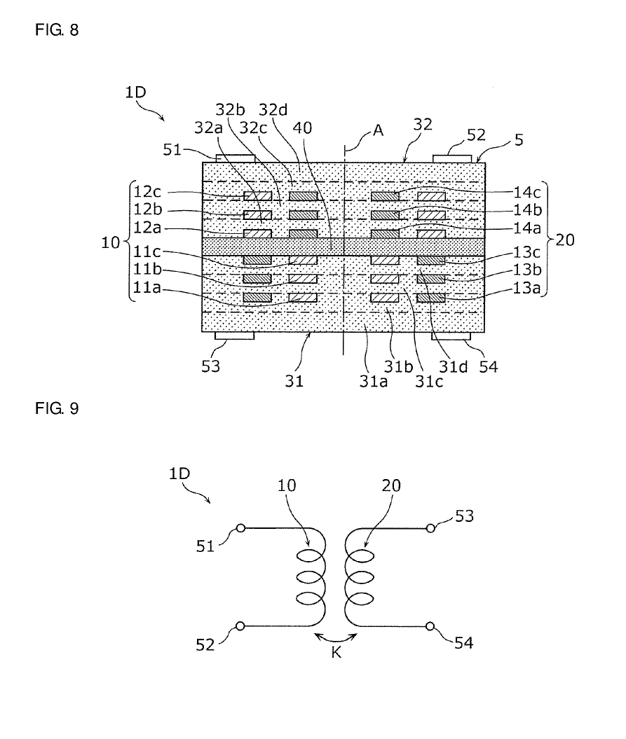

FIG. 8 is a schematic diagram illustrating a cross-section of the coil-incorporated component 1D. FIG. 9 illustrates an equivalent circuit of the coil-incorporated component 1D.

In the coil-incorporated component 1D according to the third preferred embodiment, external terminals 53 and 54 are provided on the bottom surface of the multilayer element body 5, are external terminals 51 and 52 are provided on a top surface which is a surface opposite from the bottom surface. The external terminal 51 is connected to one end and the external terminal 52 is connected to the other end of the first coil element 10. Additionally, the external terminal 53 is connected to one end and the external terminal 54 is connected to the other end of the second coil element 20.

In the coil-incorporated component 1D, when viewed from the lamination direction, the first coil pattern 11 and the fourth coil pattern 14 partially overlap with each other, the second coil pattern 12 and the third coil pattern 13 partially overlap with each other. According to this structure, in the coil-incorporated component 1D, the number of the points at which the first coil element 10 and the second coil element 20 couple with each other through the magnetic field is increased, and thus, the magnetic field coupling is improved.

Next, a circuit module 300 in which the coil-incorporated component 1D is incorporated in a resin multilayer substrate 310 will be described.

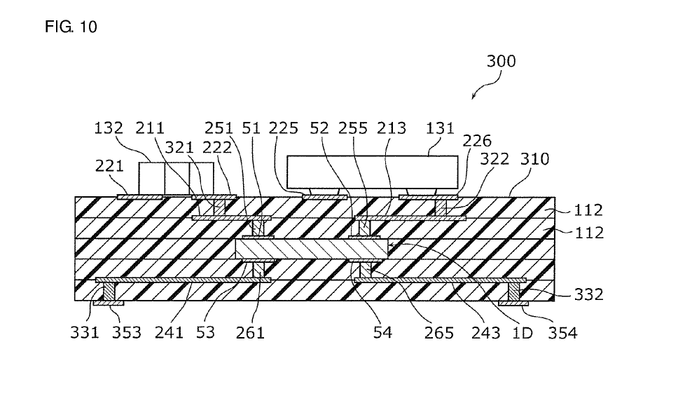

FIG. 10 is a cross-sectional view of the resin multilayer substrate 310 including the coil-incorporated component 1D in the inside thereof.

The circuit module 300 includes the resin multilayer substrate 310 and mounted components 131 and 132 mounted on the resin multilayer substrate 310. The coil-incorporated component 1D defines and functions as a transformer component between the exterior circuit and the mounted components 131 and 132.

The resin multilayer substrate 310 is a circuit substrate on which various types of electronic components are mounted and which includes a wiring pattern connecting these components. For example, the substrate is formed by stacking and pressure-bonding a plurality of resin base material layers 112. As a material of the resin base material layer 112, for example, a thermoplastic resin sheet, such as liquid crystal polymer (LCP), polyimide, or other suitable material may preferably be used.

In the resin multilayer substrate 310, various types of conductors are provided, such as, for example, in-plane conductors 211, 213, 241, and 243, interlayer conductors 251, 255, 261, 265, 321, 322, 331, and 332, top surface conductors 221, 222, 225, and 226, and other suitable conductors. On a bottom surface of the resin multilayer substrate 310, external circuit connection terminals 353 and 354 are provided.

The entire coil-incorporated component 1D is embedded in the resin multilayer substrate 310. For example, the external terminal 51 of the coil-incorporated component 1D is connected to the mounted component 132 with the interlayer conductor 251, the in-plane conductor 211, the interlayer conductor 321, and the top surface conductor 222 interposed therebetween, the external terminal 52 is connected to the mounted component 131 with the interlayer conductor 255, the in-plane conductor 213, the interlayer conductor 322, and the top surface conductor 226 interposed therebetween. The external terminal 53 is connected to the external circuit connection terminal 353 with the interlayer conductor 261, the in-plane conductor 241, and the interlayer conductor 331 interposed therebetween. The external terminal 54 is connected to the external circuit connection terminal 354 with the interlayer conductor 265, the in-plane conductor 243, and the interlayer conductor 332 interposed therebetween.

According to the present preferred embodiment, the circuit module 300 including the coil-incorporated component 1D with high magnetic field coupling is provided.

Although the coil-incorporated components according to the first, second, and third preferred embodiments and variations thereof of the present invention have been described above, the present invention is not limited to each of the first, second, and third preferred embodiments and variations thereof. One or more preferred embodiments of the present invention may also include variations obtained by adding various changes to the first, second, and third preferred embodiments and variations thereof, which are conceived by those skilled in the art, or other preferred embodiments that are configured by combining elements of the different preferred embodiments and variations thereof, as long as they do not depart from the gist of the present invention.

For example, although, in the first, second, and third preferred embodiments, the first base material layer and the second base material layer each preferably include a plurality of magnetic body layers, each of the base material layers is not limited thereto, and may include a magnetic body layer including one layer. Additionally, the intermediate layer may include one layer, or may include a plurality of layers.

For example, although, in the first, second, and third preferred embodiments, the multilayer element body preferably has a two stage structure, the multilayer element body is not limited thereto, and may have a structure of three stages or more. For example, in a case of a three stage structure, the first base material layer, the intermediate layer, the second base material layer, the intermediate layer, and the uppermost base material layer are preferably laminated in this order, a fifth coil pattern connected to the third coil pattern may be provided in the uppermost base material layer and a sixth coil pattern connected to the fourth coil pattern may be provided therein.

For example, although, in the equivalent circuit illustrated in FIG. 3, four terminals are illustrated as external terminals, one terminal may be defined by connecting the two terminals on an output side in the coil-incorporated component. Additionally, the lamination direction of the coil-incorporated component may be inverted vertically. Additionally, the coil pattern of the coil-incorporated component may include one turn, half turns, or a spiral shape, for example. Additionally, the intermediate layer may be provided such that the magnetic body layer and the intermediate layer are symmetrical in the lamination direction. By providing the intermediate layer so as to be symmetrical in the lamination direction, deformation of the multilayer element body by firing is able to be reduced.

The coil-incorporated components of preferred embodiments of the present invention may be widely used in various modes incorporated in a dual inductor, such as a common mode choke coil, a transformer, a coupler, a balun, or other suitable dual inductor, or a multilayer circuit component, such as a choke coil of a multiphase DC-DC converter, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A coil-incorporated component comprising:
a multilayer element body including a plurality of magnetic body layers that are laminated; and
a first coil element and a second coil element provided in the multilayer element body; wherein
the multilayer element body includes a first base material layer including one or more of the magnetic body layers and a second base material layer including one or more of the magnetic body layers and provided in a lamination direction with respect to the first base material layer;
the first coil element includes a first coil pattern and a second coil pattern connected to each other;
the second coil element includes a third coil pattern and a fourth coil pattern connected to each other;
the first coil pattern and the third coil pattern are provided in or on the first base material layer;
the second coil pattern and the fourth coil pattern are provided in or on the second base material layer;
when viewed from the lamination direction, the first coil pattern and the fourth coil pattern at least partially overlap with each other, the second coil pattern and the third coil pattern at least partially overlap with each other; and
an intermediate layer having a lower magnetic permeability than a magnetic permeability of the magnetic body layer is provided between the first coil pattern and the fourth coil pattern and between the second coil pattern and the third coil pattern.

2. The coil-incorporated component according to claim 1, wherein, when viewed from the lamination direction, the first coil pattern is provided in an inner side portion of the third coil pattern, and the fourth coil pattern is provided in an inner side portion of the second coil pattern.

3. The coil-incorporated component according to claim 1, wherein a coil axis of the first coil element and a coil axis of the second coil element are the same or substantially the same as each other.

4. The coil-incorporated component according to claim 1, wherein the first coil pattern and the fourth coil pattern have a same coil diameter, and the second coil pattern and the third coil pattern have a same coil diameter.

5. The coil-incorporated component according to claim 1, wherein
in the magnetic body layer in which the first coil pattern and the third coil pattern are provided, each of the first coil pattern and the third coil pattern includes one turn or less per layer of the magnetic body layer; and
In the magnetic body layer in which the second coil pattern and the fourth coil pattern are provided, each of the second coil pattern and the fourth coil pattern includes one turn or less per layer of the magnetic body layer.

6. The coil-incorporated component according to claim 1, wherein
the first base material layer includes a plurality of the first coil patterns mutually adjacent in the lamination direction and a plurality of the third coil patterns mutually adjacent in the lamination direction; and
the second base material layer includes a plurality of the second coil patterns mutually adjacent in the lamination direction and a plurality of the fourth coil patterns mutually adjacent in the lamination direction.

7. The coil-incorporated component according to claim 1, wherein the intermediate layer is provided in an entire or substantially an entire region perpendicular or substantially perpendicular to the lamination direction of the multilayer element body between the first coil pattern and the fourth coil pattern adjacent to each other in the lamination direction and between the second coil pattern and the third coil pattern adjacent to each other in the lamination direction.

8. The coil-incorporated component according to claim 1, wherein the intermediate layer is not provided between the magnetic body layer in an inner side portion of the first coil pattern and the magnetic body layer in an inner side portion of the fourth coil pattern, and is provided between the first coil pattern and the fourth coil pattern adjacent to each other in the lamination direction, between the second coil pattern and the third coil pattern adjacent to each other in the lamination direction, and between the magnetic body layer between the first coil pattern and the third coil pattern and the magnetic body layer between the second coil pattern and the fourth coil pattern.

9. The coil-incorporated component according to claim 1, wherein the magnetic body layers are made of a magnetic ferrite ceramic material.

10. The coil-incorporated component according to claim 9, wherein the magnetic ferrite ceramic material includes iron oxide as a primary component and at least one or more of zinc, nickel, and copper.

11. The coil-incorporated component according to claim 1, wherein the first coil pattern, the second coil pattern, the third coil pattern, and the fourth coil pattern have the same or substantially the same width dimension.

12. The coil-incorporated component according to claim 1, wherein the first coil pattern and the fourth coil pattern same or substantially the same thickness dimension.

13. The coil-incorporated component according to claim 1, wherein the second coil pattern and the third coil pattern same or substantially the same thickness dimension.

14. The coil-incorporated component according to claim 1, wherein each of the first coil pattern, the second coil pattern, the third coil pattern, and the fourth coil pattern is made of a metal or an alloy including silver as a primary component.

15. The coil-incorporated component according to claim 14, wherein each of the first coil pattern, the second coil pattern, the third coil pattern, and the fourth coil pattern includes a plating layer made of nickel, palladium, or gold.

16. The coil-incorporated component according to claim 6, wherein each of the plurality of first coil patterns has the same or substantially the same width, each of the plurality of second coil patterns has the same or substantially the same width, each of the plurality of third coil patterns has the same or substantially the same width, each of the plurality of fourth coil patterns has the same or substantially the same width.

17. The coil-incorporated component according to claim 6, wherein adjacent ones of the plurality of first coil patterns in the lamination direction have different widths, adjacent ones of the plurality of second coil patterns in the lamination direction have different widths, adjacent ones of the plurality of third coil patterns in the lamination direction have different widths, adjacent ones of the plurality of fourth coil patterns in the lamination direction have different widths.

18. The coil-incorporated component according to claim 1, wherein a plurality of the intermediate layers having a lower magnetic permeability than a magnetic permeability of the magnetic body layer are provided between the first coil pattern and the fourth coil pattern and between the second coil pattern and the third coil pattern.
